(19) United States
(12) Patent Application Publication
(10) Pub. No.: US 2008/0267463 A1
(43) Pub. Date: Oct. 30, 2008

(54) FINGERPRINT IDENTIFICATION APPARATUS AND PORTABLE ELECTRONIC DEVICE HAVING SAME

(75) Inventor: KUN-I YUAN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/923,040

(22) Filed: Oct. 24, 2007

(30) Foreign Application Priority Data
Apr. 25, 2007 (CN) 200710200505.2

(51) Int. Cl. G06K 9/00

(52) U.S. Cl. 382/124

(57) ABSTRACT

A fingerprint identification apparatus includes an image pickup module and a digital camera module. The image pickup module including a beam splitter that includes a first surface, a second surface adjoining the first surface, a third surface opposite to the second surface; and a lighting module disposed facing towards the first surface and configured for emitting parallel light beams toward the first surface. The digital camera module is disposed facing towards the second surface and configured for capturing a fingerprint of a user or taking pictures; and a fingerprint identification module for distinguishing similarity between the captured fingerprint and a previously registered image.

### BACKGROUND

1. Technical Field

The present invention generally relates to a fingerprint identification apparatus and a portable electronic device having same.

2. Description of Related Art

With the trend toward a highly mobile workforce, the use of portable electronic devices such as mobile phone and personal digital assistant (PDA) are growing at an ever-increasing rate. These devices offer a variety of functions that are quickly becoming a necessity in people's daily life. A mobile phone usually has the function of storing personal information including communication records, contact information, daily events and so on. Consequently, a passcode is usually required for accessing and protecting personal information in a mobile phone. However, only several numbers are allowed for the passcode of mobile phones. The passcode can easily be deciphered, which makes personal information vulnerable. Therefore, a mobile phone having a fingerprint identification apparatus can achieve a high degree of safety for protection. The fingerprint identification apparatus in the mobile phone, for example, can verify that a user's fingerprints are in fact the fingerprints of its owner, and subsequently grant access to the functions and information therein.

A conventional fingerprint identification apparatus of a mobile phone consists of two pieces of material, the first piece is transparent with adhesive on a side, the second piece has a side coated with a substance that would not adhere to the adhesive, this second piece is folded in the centre making two flaps, one flap having an opening with adhesive material provided on the outside. When the fingertip is placed on the adhesive surface of the first material, natural oils and dust are lifted from the finger leaving a clean and clear fingerprint on the adhesive. When the fold is closed, the non-adhering surface lies on the adhesive and protects the fingerprint until it had to be examined then the non-adhering surface on the flap lifts easily. Since, such fingerprint identification apparatus needs to collect a sample of the fingerprint and then to exam the sample, this result in that the operation is discommodious, especially that the fingerprint identification apparatus cannot identify the fingerprint of the user instantly, it is not an ideal fingerprint identification apparatus to be used in a portable electronic device.

What is needed, is a fingerprint identification apparatus that can instantly identify the fingerprint of a user, thus making the fingerprint identification more convenient when used in a portable electronic device.

### SUMMARY

A first present embodiment provides a fingerprint identification apparatus. The fingerprint identification apparatus includes: an image pickup module and a digital camera module. The image pickup module includes a beam splitter, a lighting module and a fingerprint identification module. The beam splitter includes a first surface, a second surface adjoining the first surface, a third surface opposite to the second surface. The lighting module is disposed facing towards the first surface and used to emit parallel light beams toward the first surface. The digital camera module is disposed facing towards the second surface, and being used to capture a fingerprint of a user or taking pictures. The fingerprint identification module is used to distinguish similarity between the captured fingerprint and a previously registered image.

A second present embodiment provides a fingerprint identification apparatus. The fingerprint identification apparatus includes an image pickup module and a fingerprint identification module. The image pickup module comprising: a light source for emitting parallel light beams; a beam splitter having a first input port for receiving light beams in a first direction from a fingerprint of a user, a second input port for receiving the light beams in a second direction from the light source, and an output port for outputting the light beams along the first direction therefrom, the first direction being perpendicular to the second direction; a digital camera module for capturing an image of the fingerprint of a user or taking pictures. The fingerprint identification module is used to distinguish similarity between the captured fingerprint and a previously registered image.

A third present embodiment provides portable electronic device, includes: a main body which has a display screen; and a fingerprint identification apparatus mounted on the main body. The fingerprint identification apparatus includes: an image pickup module, a digital camera module and a fingerprint identification module. The image pickup module includes a beam splitter and a lighting module. The beam splitter includes a first surface, a second surface adjoining the first surface, a third surface opposite to the second surface. The lighting module is disposed facing towards the first surface and used to emit parallel light beams toward the first surface. The digital camera module is disposed facing towards the second surface, and being used to capturing a fingerprint of a user or taking pictures. The fingerprint identification module is used to distinguish similarity between the captured fingerprint and a previously registered image.

Other advantages and novel features will become more apparent from the following detailed description of preferred embodiments when taken in conjunction with the accompanying drawings.

### BRIEF DESCRIPTION OF THE DRAWINGS

Many aspects of the present fingerprint identification apparatus and portable electronic device can be better understood with reference to the following drawings. The components in the drawings are not necessarily drawn to scale, the emphasis instead being placed upon clearly illustrating the principles of the present glue dispenser. Moreover, in the drawings, like reference numerals designate corresponding parts throughout the several views.

FIG. 1 is a schematic, cross-sectional view of a fingerprint identification apparatus according to a first preferred embodiment;

FIGS. 2 and 3 are schematic, light path views of carrying out fingerprint identification by the fingerprint identification apparatus in FIG. 1;

FIG. 4 is schematic, light path view of taking a picture by the fingerprint identification apparatus in FIG. 1;

FIG. 5 is a schematic, cross-sectional view of a fingerprint identification apparatus according to a second preferred embodiment; and

FIG. 6 is a schematic, cross-sectional view of a portable electronic device including the fingerprint identification apparatus in FIG. 1, according to a third preferred embodiment.

The exemplifications set out herein illustrate various preferred embodiments, in various forms, and such exemplifications are not to be construed as limiting the scope of the present fingerprint identification apparatus and portable electronic device in any manner.

### DETAILED DESCRIPTION

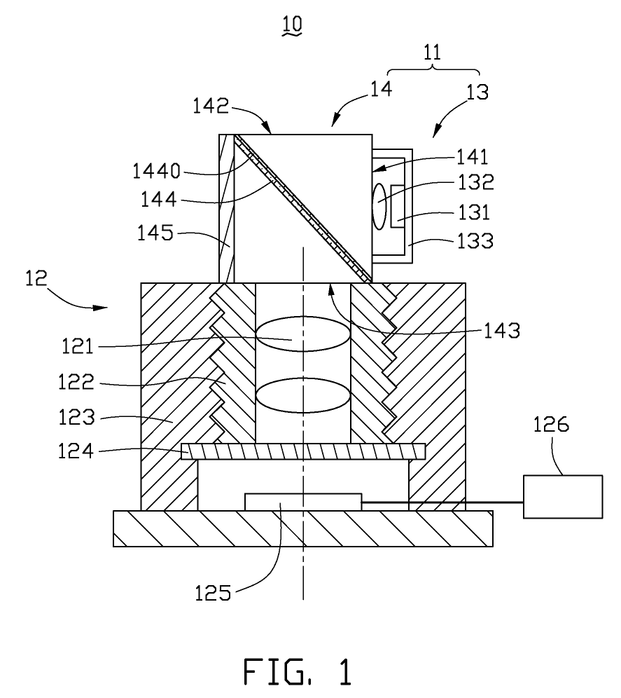

Referring to FIG. 1, a fingerprint identification apparatus 10, in accordance with a first present embodiment, is shown. The present fingerprint identification apparatus 10 includes an image pickup module 11, and a digital camera module 12.

The image pickup module 11 includes a lighting module 13 and a beam splitter 14 placed on the opposite side of the lighting module 13.

The lighting module 13 includes a light source 131 and a collimating lens 132 disposed opposite to the light source 131. The collimating lens 132 is used to transform light beams emitted from the light source 131 into parallel light. The light source 131 can be a semiconductor light emitting diode (LED), an organic light emitting diode (OLED), a combination of an edge-lighting type light guide plate with at least a LED, etc. In this embodiment, the light source 131 is a semiconductor LED.

It can be understood that the lighting module 13 can be provided without the collimating lens 132 when the light source 131 can directly emit the parallel light beams itself, for example, the light source 131 is a combination of an edge-lighting type light guide plate with at least one semiconductor LED, so that the light source 131 can be placed directly opposite to the beam splitter 14.

The lighting module 13 further includes a square shell 133 used to receive the light source 131 and the collimating lens 132 therein. Furthermore, a reflective film is suitably coated on inner surface of the shell 133 and configured for improving utilization ratio of the light emitted from the light source 131.

The beam splitter 14 includes an incident surface 141, a first emitting surface 142 adjoining the incident surface 141, a second emitting surface 143 opposite to the first emitting surface 142, and a glass plate 144 obliquely located between the first emitting surface 142 and the second emitting surface 143, a beam splitting film 1440 is coated on the glass plate 144. The incident surface 141 is opposite to the lighting module 13. The second emitting surface 143 is next to the digital camera module 12 and perpendicular to the incident surface 141. The beam splitting film 1440 can be a dielectric optical film or a metallic film. In this embodiment, the beam splitting film 1440 is an aluminum film.

The image pickup module 11 further includes a reflective film 145. The reflective film 145 is coated on a surface of the beam splitter 14 that is opposite to the incident surface 141.

The digital camera module 12 includes several lenses 121, a lens barrel 122, a lens holder 123, a glass plate 124, an image sensor 125 and a fingerprint identification module 126. The several lenses 121 are received in the lens barrel 122. The lens barrel 122 is held in the lens holder 123 by engaging an internal thread of the lens holder 123 together with an external thread of the lens barrel 122. The glass plate 124 is placed in the lens holder 123 and located between the lens 121 and the image sensor 125, which is used to protect the image sensor 125 from contamination. The image sensor 125 is used to convert an optical signal into an electronic signal. The fingerprint identification module 126 is electrically connected with the image sensor 125. There is a fingerprint information should be stored in advance in the fingerprint identification module 126.

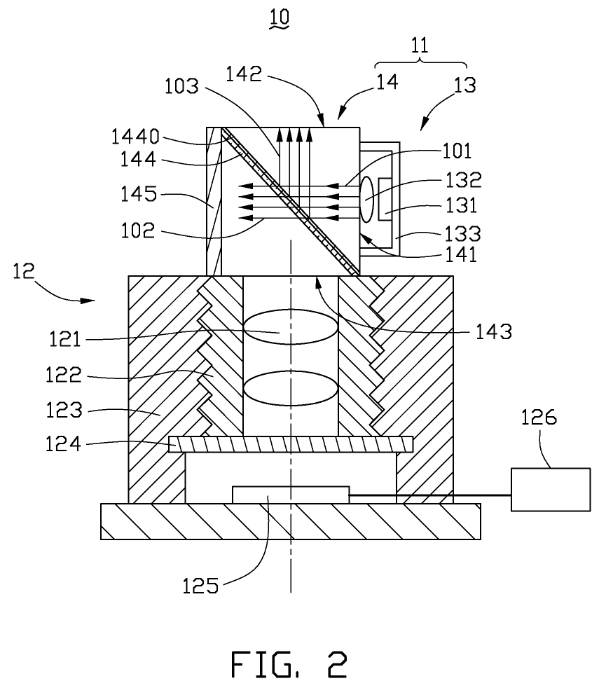

Referring to FIG. 2, parallel light beams 101 emitted from the lighting module 13 are incident into the beam splitter 14 by the incident surface 141 at a 45 degree angle advantageously, and then being separated into a first light beam 102 and a second light beam 103 with a same spectral component substantially, the first light beam 102 and the second light beam 103 are respectively incident into the reflective film 145 and the first emitting surface 142.

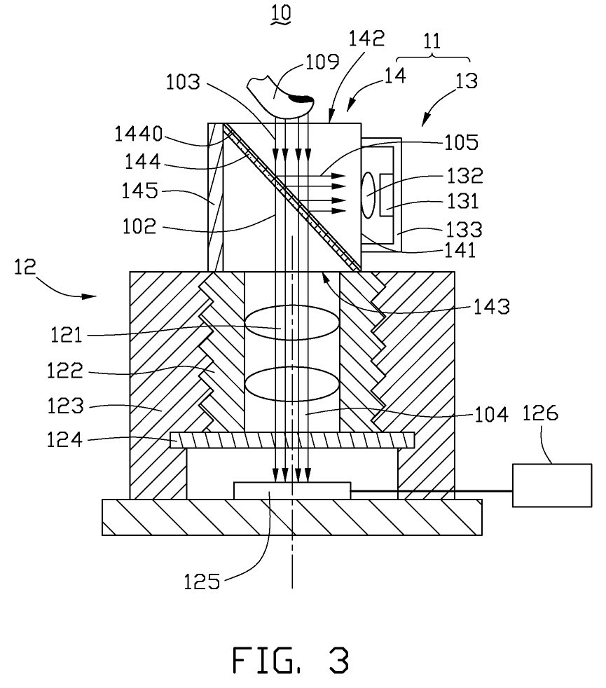

Referring to FIG. 3, the second light beam 103 is again incident into the beam splitter 14 after being reflected by a finger 109 that placed on the first emitting surface 142, and then separates into a third light beam 104 and a fourth light beam 105 with a same spectral component substantially by the beam splitting film 1440. The third light beam 104 and the fourth light beam 105 are respectively incident into the digital camera module 12 and the lighting module 13. The digital camera module 12 capture the fingerprint of the finger 109, that is, the image sensor 125 of the digital camera module 12 receives the third light beam 104 passed through the several lens 121, and converts the third light beam 104 into electronic signals correspondingly. The fingerprint identification module 126 then compares the electronic signals generated from the image sensor 125 with fingerprint information stored in advance to distinguish similarity between the captured image and a previously registered image so as to recognize the identification of the fingerprint.

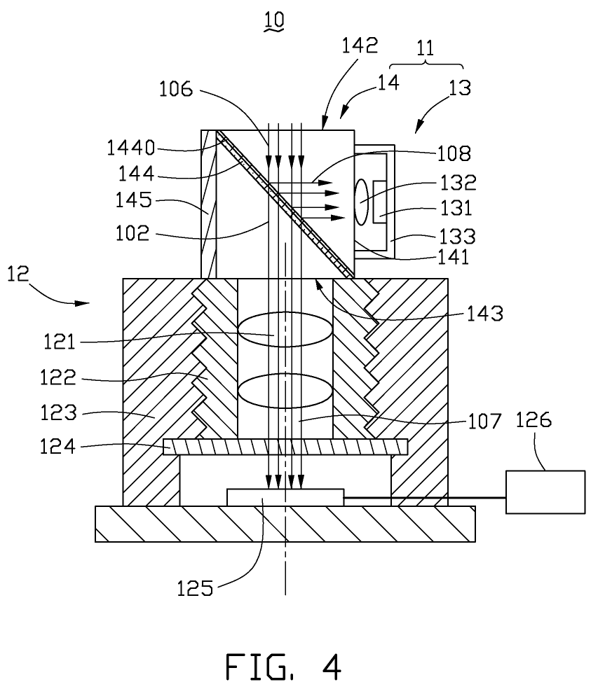

Referring to FIG. 4, when taking pictures with the present fingerprint identification apparatus 10, the first emitting surface 142 is provided in the direction facing towards the area where the image is to be taken, and the lighting module 13 is switched off. Light beams 106 reflected from the area is incident into the beam splitter 14, and then separated into a third light beam 107 and a fourth light beam 108 with a same spectral component substantially by the beam splitting film 1440. The third light beam 107 is incident into the digital camera module 12 after passing through the second emitting surface 143, and the fourth light beam 108 is incident into the lighting module 13. The image sensor 125 of the digital camera module 12 receives the third light beam 107 passed through the several lenses 121, and converts the third light beam 107 into electronic signals correspondingly. An image storage system (not shown) of the digital camera module 12 then saves the electronic signals therein, so as to realize the function for taking picture of the fingerprint identification apparatus 10.

As described above, the fingerprint identification apparatus 10 with simple structure is used for capturing and identifying fingerprint of the user with the assistance of the glass plate 144 with beam splitting film 1440 coating thereon, so that the fingerprint identification apparatus 10 can instantly identify the fingerprint of a user. In addition, the fingerprint identification apparatus 10 can also function as a camera for taking pictures.

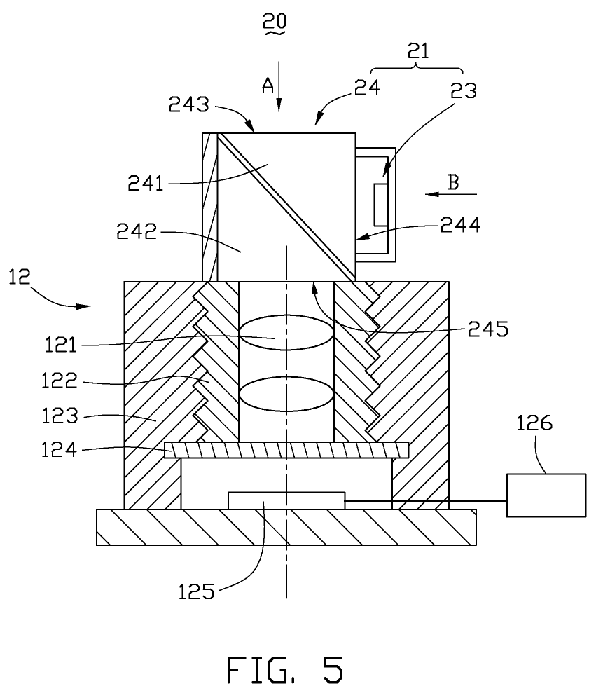

Referring to FIG. 5, a fingerprint identification apparatus 20, in accordance with a second present embodiment, is shown. The fingerprint identification apparatus 20 is approximately same as that of the fingerprint identification apparatus 10, the difference is the image pickup module.

The fingerprint identification apparatus 20 includes an image pickup module 21 with a lighting source 23 for emitting parallel light beams and a beam splitter 24 disposed on the opposite side of the lighting source 23. The beam splitter 24 includes a first triangular prism 241 and a second triangular prism 242 which adhered with the first triangular prism 241. The first prism 241 and the second prism 242 together cooperatively formed an integral rectangular prism bisected by a junction of the triangular prisms.

The integral rectangular prism formed by the first prism 241 and the second prism 242 includes a first input port 243 facing towards the area where the image is to be taken, a second input port 244 adjoining the lighting source 23, and an output port 245 opposite to the first input port 243. The first input port 243 is used to receive light beams in a first direction A from a fingerprint of a user or scenery. The second input port 244 could receive the light beams in a second direction B from the lighting source 23 when the lighting source 23 emitting the parallel light toward itself. The output port 245 is used to output the light beams along the first direction A from the first input port 243 to the digital camera module 12. In this embodiment, the first direction A is perpendicular to the second direction B.

The fingerprint identification apparatus 20 can also capture fingerprint information accurately by using the integral rectangular prism formed by the first prism 241 and the second prism 242. In addition, the fingerprint identification apparatus 20 can also be used for taking pictures.

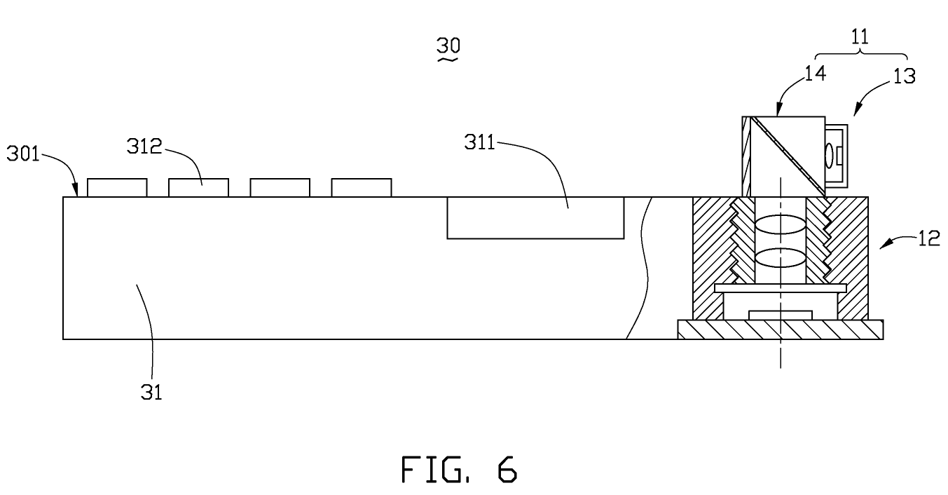

Referring to FIG. 6, a portable electronic device 30 including the fingerprint identification apparatus 10 described above, in accordance with a third present embodiment, is shown. The portable electronic device 30 includes a main body 31 having a display screen 311 and a keystroke part 312 on a surface 301 thereof. The digital camera module 12 of the fingerprint identification apparatus 10 is located in the main body 31 and next to the display screen 311. The image pickup module 11 is disposed on the main body 31 facing towards the lens barrel 122 of the digital camera module 12. It can be understood that the keystroke part 312 can be placed on an adjacent surface of the surface 301, instead.

In this embodiment, functions for fingerprint identification and image capturing of the portable electronic device 30 are approximately same as that of the fingerprint identification apparatus 10. When the portable electronic device 30 is in operation, the functions of fingerprint identification and image capturing can be switched easily.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fingerprint identification apparatus comprising:
an image pickup module comprising:
a beam splitter including a first surface, a second surface adjoining the first surface, a third surface opposite to the second surface; and
a lighting module disposed facing towards the first surface and configured for emitting parallel light beams toward the first surface; and
a digital camera module disposed facing towards the second surface, the digital camera module being configured for capturing a fingerprint of a user or taking pictures; and
a fingerprint identification module for distinguishing similarity between the captured fingerprint and a previously registered image.

2. The fingerprint identification apparatus of claim 1, wherein the lighting module comprises a light source and a collimating lens, the collimating lens being disposed between the light source and the first surface of the beam splitter.

3. The fingerprint identification apparatus of claim 2, wherein the light source is selected from a group consisting of a semiconductor light emitting diode, and an organic light emitting diode.

4. The fingerprint identification apparatus of claim 1, further comprising a reflective film coated on a surface of the beam splitter that is opposite to the first surface.

5. The fingerprint identification apparatus of claim 1, wherein the beam splitter further includes a glass plate with a beam splitting film coating thereon, the parallel light beams incidence at a 45 degree angle.

6. The fingerprint identification apparatus of claim 5, wherein the beam splitting film is selected from a group consisting of a dielectric optical film and a metallic film.

7. A fingerprint identification apparatus comprising:
an image pickup module comprising:
a light source for emitting parallel light beams;
a beam splitter having a first input port for receiving light beams in a first direction from a fingerprint of a user, a second input port for receiving the light beams in a second direction from the light source, and an output port for outputting the light beams along the first direction therefrom, the first direction being perpendicular to the second direction;
a digital camera module for capturing an image of the fingerprint of a user or taking pictures; and
a fingerprint identification module for distinguishing similarity between the captured fingerprint and a previously registered image.

8. The fingerprint identification apparatus of claim 7, wherein the beam splitter includes first and second triangular prisms adhered to each other, the first and second prisms cooperatively forming an integral rectangular prism bisected by a junction of the triangular prisms.

9. A portable electronic device comprising
a main body having a display screen; and
a fingerprint identification apparatus mounted on the main body, the fingerprint identification apparatus comprising:
an image pickup module comprising:
a beam splitter including a first surface, a second surface adjoining the first surface, a third surface opposite to the second surface; and
a lighting module disposed facing towards the first surface and configured for emitting parallel light beams toward the first surface; and
a digital camera module disposed facing towards the second surface, the digital camera module configured for capturing a fingerprint of a user or taking pictures; and
a fingerprint identification module for distinguishing similarity between the captured fingerprint and a previously registered image.

10. The portable electronic device of claim 9, wherein the fingerprint identification apparatus further comprises a reflective film coated on a surface of the beam splitter that is opposite to the first surface.

11. The portable electronic device of claim 9, wherein the beam splitter further includes a glass plate with a beam splitting film coating thereon, the parallel light beams incidence at a 45 degree angle.

12. The portable electronic device of claim 11, wherein the beam splitting film is selected from a group consisting of a dielectric optical film and a metallic film.
